(19) United States
(12) Patent Application Publication
(10) Pub. No.: US 2017/0291050 A1
(43) Pub. Date: Oct. 12, 2017

(54) Multi-Functional Fire Attack System

(71) Applicant: Michael Joseph Boyle, New Boston, NH (US)

(72) Inventor: Michael Joseph Boyle, New Boston, NH (US)

(21) Appl. No.: 15/481,613

(22) Filed: Apr. 7, 2017

Related U.S. Application Data
(60) Provisional application No. 62/319,769, filed on Apr. 7, 2016.

(51) Int. Cl. A62C 2/06; A62C 31/00; A62C 31/05; F16L 5/04; A62C 31/22

(52) U.S. Cl. CPC A62C 3/14; A62C 2/06; F16L 5/04; A62C 31/22; A62C 31/05; A62C 31/005

(57) ABSTRACT

The present invention concerns a portable building fire suppression system which allows fire-fighters to position the device within a building early on in the firefighting process. The device may use automated controls to begin fire suppression. Further, a number of electronics including lighting, smoke detection, alarms, camera, motion sensor, and the like may be included on the portion of the device inserted into the building. These electronic systems may provide vital information early in the firefighting process to inform fire fighters about conditions within the building.

### BACKGROUND OF THE INVENTION

### 1. Field of the Invention

This invention relates to the technical field of firefighting. More specifically, this invention comprises improvements in the technical field of fire nozzles.

### 2. Description of the Prior Art

There are many types of fire nozzles in the related art, among the most common are:

1. Smooth Bore

2. Fixed-GPM (gallons per minute)/Variable Stream/Constant Flow

3. Automatic Variable Flow and Stream

4. Broken or Aspirated Stream

Interior fire fighting is typically conducted by two or three firefighters. They coordinate their entry and drag a fire hose with a nozzle into the structure and search for the seat of the fire. After they reach the fire, they call for a “vent” by radio to the exterior vent crew. The vent crew is responsible for providing a timely vent on the same floor and in the area of the fire. The vent can be vertical (through the roof) or horizontal (through the door or window). The vent crew always waits for the interior crew to be in position. Opening up the exterior prematurely can introduce oxygen rich air causing a dramatic increase in fire behavior. After ventilation is completed, and the vent crew is safely away from the structural opening, the interior crew deploys a systematic delivery of water to the ceiling and seat of the fire. Having a ventilation hole allows the interior crew to extinguish and push the heat, smoke, and steam out through the exterior opening. This has been the tried and true practice for decades in the fire service.

Presently firefighters carry a multitude of tools to accomplish interior fire attack. They wear full PPE (personal protective equipment) and use a SCBA (self contained breathing apparatus) of which the combined weights can be over 50 pounds. Most every fire fighter also carries at least one tool, usually a Fire Axe, Pike Pole or Halligan. At least one of the crew also carries a TIC (thermal imaging camera) and a radio. Fire fighters check the entry door for heat, and then enter the structure dragging a charged line with an automatic variable flow nozzle, searching for the seat of the fire. In most cases, the entry door is held open by the advancing hose line thus allowing a large amount of oxygen rich air to enter the structure. Entering an unfamiliar structure and trying to navigate to the seat of the fire is time consuming and exhausting. A typical pre-connected 1¾″ line at 200 feet weighs approximately 284 lbs. when charged. A 2½″ line at 200 feet weighs approximately 532 lbs. when charged. Historically, attempts to extinguish interior fires from the exterior have been viewed as forbidden practices, since breaking or forcing a door or window will permit oxygen rich air to enter the structure and intensify and spread the fire. Also, an exterior hose stream directed into the building could endanger the occupants or firefighters. The hose stream can drive the fire, create unpredictable thermal layer disruptions, cause visibility issues, or hit personnel. Studies have indicated that openings in the structure can create flow paths and increase fire behavior dramatically. A significant number of the firefighter fatalities involve rapidly changing fire conditions associated with ventilation and flow paths.

A report from Scientific Research for the Development of More Effective Tactics, based on their work on the Governors Island Experiments of 2012, in conjunction with NIST (National Institute of Standards and Technology), U.L. (Underwriters Laboratories) and the FDNY (Fire Department of New York) reached several conclusions.

The following are some of the major conclusions from the report.
Opening up the doorways and windows could created dangerous flow paths.
Anyone in between the fire and an exhaust portion of a flow path was in a high hazard location.
The earlier the fire suppression the better.
Aggressive exterior attack through a window into a fire room improved fire behavior and occupant survivability.
Some fire departments refer to the above tactics as early water, blitz attack, resetting the fire, or transitional attack.
   Interesting research from the above report and other reports from the U.L., NIOSH (National Institute of Occupational Safety and Health), and NIST, suggest that it may be time to develop safer interior fire attack strategies.

### BRIEF SUMMARY OF THE INVENTION

The Multi-Function Fire Attack System comprises two major components. The first is the Multi-Function Fire Attack Device and the second is the Self-Sealing Fire Hose Pass-Through Device.

The Multi-Functional Fire Attack Device is to be used primarily by fire officers or senior firefighters to safely and rapidly deploy dry chemical, water, foam, or gas extinguishing agents through a window into a structure. The preferred embodiment of the invention is to be pre-connected to a 1½″ hose on a fire truck. When the fire truck arrives on scene, this invention would be the first tool off the truck. It would then be carried to the visible area of the fire and slammed through the nearest window or door glass, and securely held in place by the stability hooks for unmanned operation. The device may have a smoke detecting sensor such that smoke in the building may automatically activate at least one of the following optional features:
1. A distinct alarm which may serve as a:
   a. Interior and exterior fire locator.
   b. Disorientated firefighter orientation signal.
   c. Device activation signal.
   d. Building evacuation alarm.
2. An interior strobe light, which may serve as a fire locator.
3. An exterior strobe light, which may serve as a signal to fire ground personnel of invention activation.
4. Interior motion detector for fire victims, with wireless receiver for command.
5. A wireless remote infrared color camera with wireless monitors.

The adjustable height device in the hands of the average firefighter can reach nearly 15 feet. This is enough height to reach basement windows, first floor windows, and most second floor windows without using the available extensions, portable fire extinguisher stepladder, or a fire ladder. Many options are available for the fire attack. A pre-connected fire extinguisher can be quickly discharged into the fire room through the device. After that, in most cases, command will radio the pump operator to charge the hose line (50 pounds to 300 pounds) and a Bi-Directional 4-Function Nozzle will deploy a fine spray directed upward at the ceiling for steam conversion. The pre-connected fire hose allows fire command the options of high or low-pressure water for steam conversion. Steam conversion dramatically lowers the interior ceiling temperatures and inhibits “rollover” and “flashover” conditions, while simultaneously protecting the structure from the typical 40 to 60 percent water damage caused from standard attack lines. This feature also preserves the limited water available, especially in rural communities. In some embodiments, the device nozzle may be capable of creating a deluge of type A or B foam delivered from the pre-connected hose. In a further embodiment, a cone shaped spray pattern from the bi-directional 4-function nozzle will spray back toward the broken glass or structure opening. The rear facing spray pattern, through rear facing nozzle or nozzles, may inhibit the outside air from entering the structure. This device can be left unmanned to free up the officer for command duties. Firefighters who deploy the device of the present invention could move on to ventilation, interior attack, or other fire ground duties.

The Multifunctional Fire Attack Device can be deployed by the officer in command while doing their 360-degree survey of the fire ground. This attack can be successfully done within seconds of arriving on scene. It is probably the fastest most versatile interior attack in the business. Since a serious fire attack would be underway after deployment of the multifunctional fire attack device, there is less need for a hasty interior attack. Command may wish to hit the fire with more dry chemical or water to improve the fire conditions, before committing firefighters to the interior.

A firefighter waiting to enter a building for interior firefighting can install the Self-Sealing Hose Pass-Through Devices using a special tool. Two pass-through devices contemplated herein can be installed with a slight overlap to allow for large bails and pistol grips on nozzles. Two of the pass-through devices mounted on a hinge side of the door together will allow for an attack line as well as at least one back up line. Other pass-through devices can be added for more lines. The inventive pass-through device allows for the use of the door for entry and egress, while still preserving the sealing effect from shutting the door. This feature is key to improving firefighter safety, since uncontrolled air infiltration and subsequent rapid changing fire behavior, is responsible for many firefighter injuries and deaths.

Turning again to the multifunctional fire attack device, once the electronics are activated by the smoke detector detecting a predetermined level of smoke, heat, or the like, command may view the inside conditions with their wireless receiver. This camera allows them to see below the ceiling smoke in regular color, since the device is most often deployed at the bottom of a window. In smoke filled areas, the infrared camera will produce a shadow image. A motion sensor set for the infrared spectrum, between 8-14 micro wavelength, will trigger an audible alert if inside motion is detected (viable human life). Firefighters with full PPE should not set off the victim alert. The strobe and distinct alarm serve as a locator for crews searching for the fire area, usually entering from the other end of the structure. The alarm also becomes an instant orientation device in the event the interior crews become disorientated in the smoke. They can remember which side of the building the invention was deployed on to regain their bearings. The brightly colored invention has an exterior strobe to signal arriving crews that this invention has been activated. Upon seeing this invention or hearing its distinct sound, the firefighters immediately know several things:

1. Aggressive interior fire attack has begun.
2. Ceiling temperatures are being protected against “rollover” or “flashover” conditions.
3. Firefighters will have a visible and audible locator to help quickly direct them to the fire area.
4. A potential safe haven can be found under the ceiling spray of the nozzle.
5. They can work in the room without having nozzle spray directed right at them.
6. A secure self-rescue rope anchor is available to them on the invention in case of rapidly changing fire conditions or building collapse.
7. A last resort emergency safety slide is available, if they need to bail out by sliding down the securely fastened rigid pipe, past the smooth coupling and hose to the ground. Of course training will have to be done for firefighters to fully appreciate all the features, safety functions, and limitations of this invention.

### BRIEF DESCRIPTION OF THE SEVERAL VIEWS OF THE DRAWINGS

FIG. 1 is a perspective view, showing the present invention.

FIG. 2 is a cut away illustration of this invention activated in a second story window.

FIG. 3 shows an exploded view of the Automatic Bi-Directional 4-Function Nozzle.

FIG. 4 provides a view of an embodiment of the sealing hose pass-through device in position on a door having a hose passed through the device and in turn the door.

FIG. 5 provides a side view of a door sweep of the present invention.

FIG. 6 provides a front view of a door sweep of the present invention.

FIG. 7 provides a detail view of an embodiment of a nozzle assembly.

FIG. 8 provides a detail view of an embodiment of a nozzle assembly.

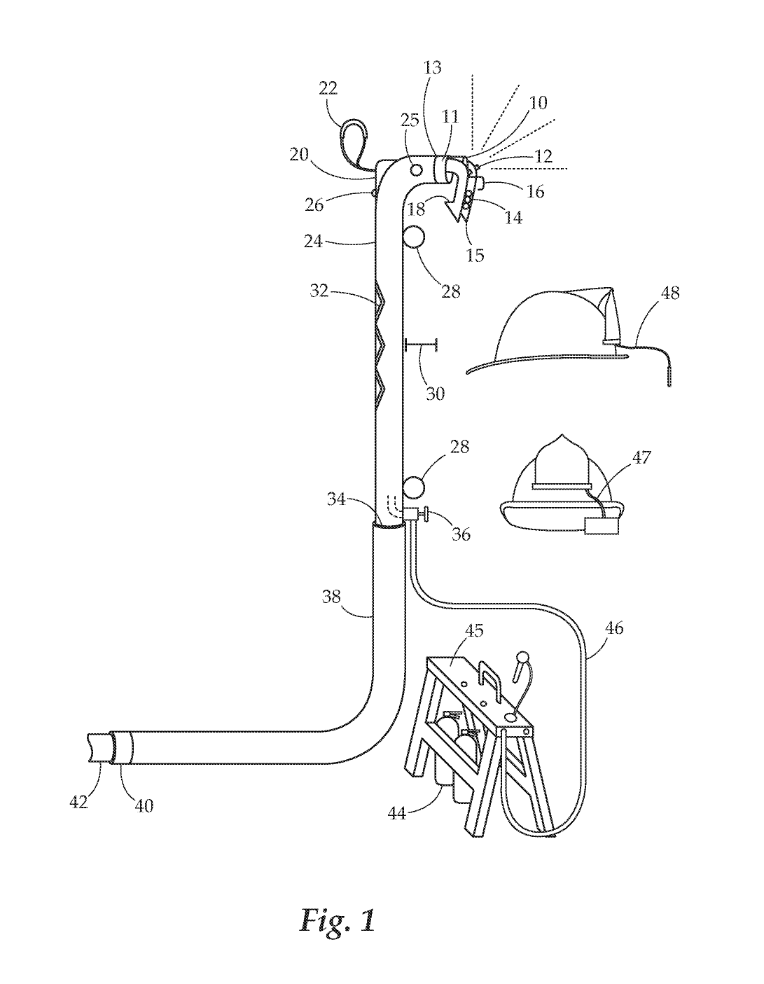

### REFERENCE NUMERALS IN THE DRAWINGS FOR FIGS. 1, 2, AND 4

10 Automatic Bi-Directional 4-Function nozzle
11 Infrared Camera
12 Tempered Glass/Multi-Pane Glass Breakers
13 Motion Sensor
14 Interior strobe Light/visual fire room locator
15 Stability Hooks
16 Screen and Shutter Ripper
18 Stability Hook Spurs
20 Battery Compartment with on, off, and automatic selection for alarm, strobe, camera, and motion sensor
22 Emergency Bailout Handle and rope anchor
24 Rigid Pipe
25 Alarm Speaker
26 Exterior Strobe Light
28 Weeping Structure Offsets
30 Necessary space between structure and pipe
32 Reflective Decals, and heat sensitive decals
34 Smooth Coupling Joint
36 Extinguisher Connection
38 Weeping Fire Hose
40 Coupling
42 Standard Fire Hose
44 Extinguisher
45 Twin Extinguisher Pack with Stepstool
46 Extinguisher Hose Extension
47 Wireless Monitor attached to fire helmet in viewing position
48 Wireless Monitor side view of helmet
49 Self-Sealing Hose Pass-Through Device

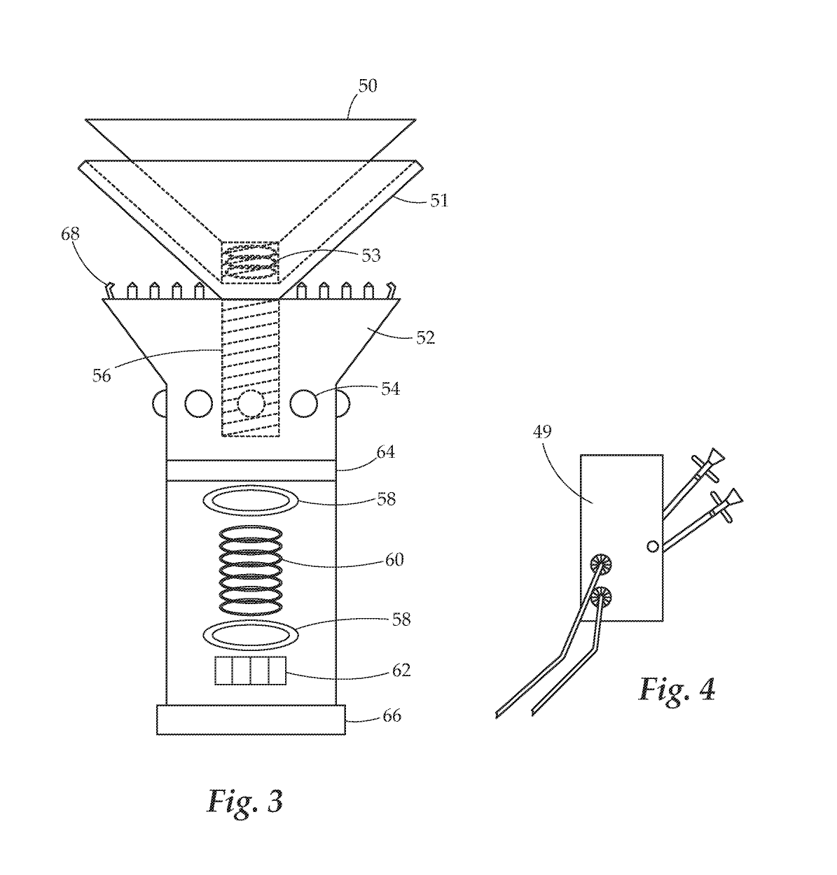

### REFERENCE NUMERALS IN THE DRAWINGS FOR FIG. 3

50 Automatic Low-Pressure Tip
51 Automatic High-Pressure Tip
52 Nozzle Housing and discharge area
53 Low-Pressure to High-Pressure Compression Spring
54 Reverse Flow Ports
56 Threaded rod portion of low-pressure tip
58 Washers
60 Automatic Gallon Compression Spring
62 Nut
64 Internal Tip Mount
66 Female Threaded Coupling
68 Water Break-up Teeth

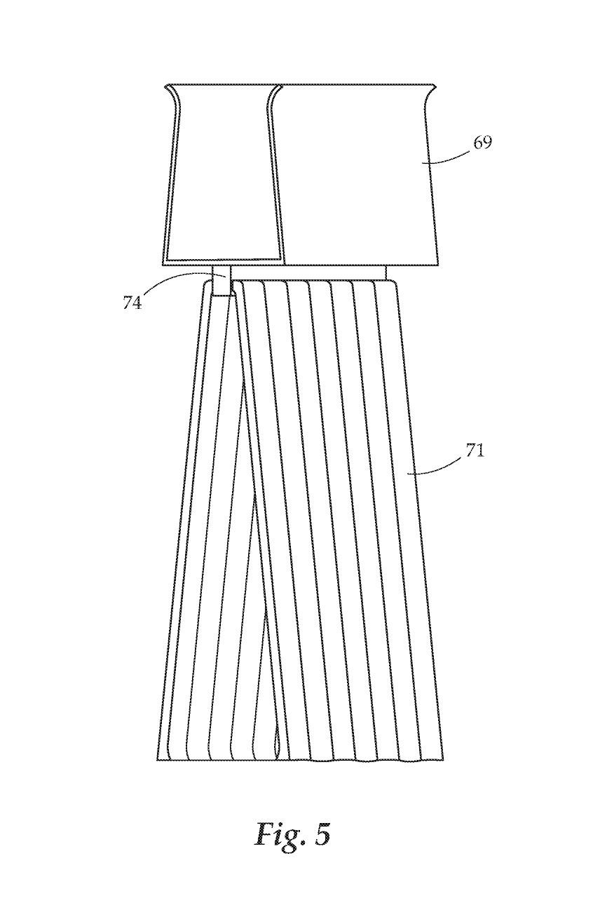

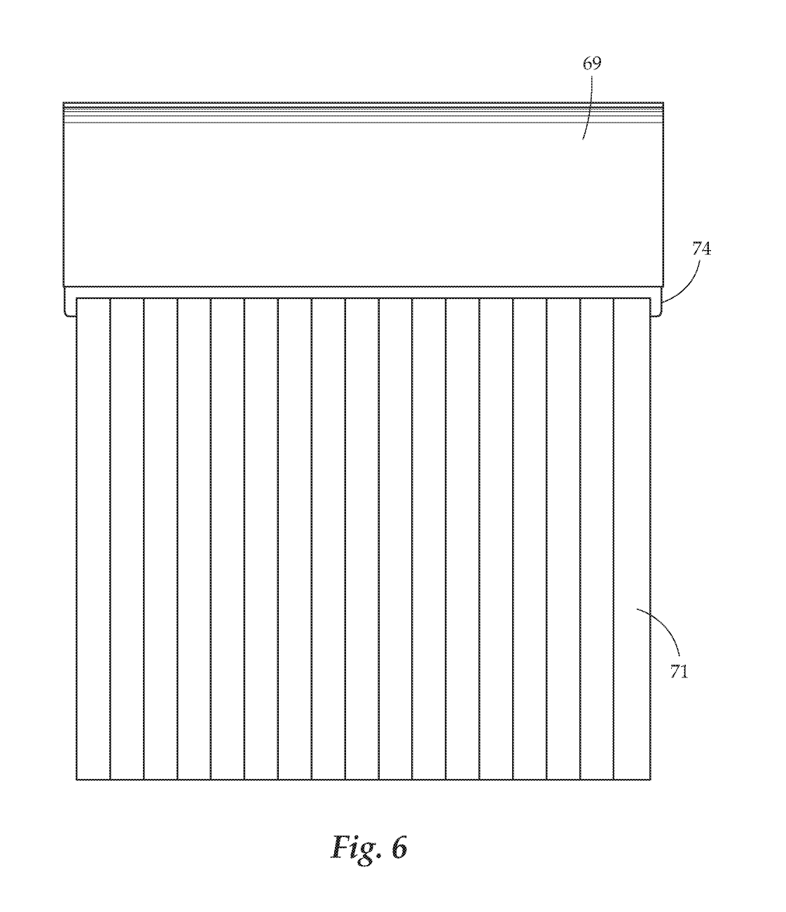

### REFERENCE NUMERALS IN THE DRAWINGS FOR FIGS. 5 AND 6

69 Metal door connector
71 Non-combustible material to act as a door sweep and allow hoses to pass through
74 Connector between non-combustible material and door connector.

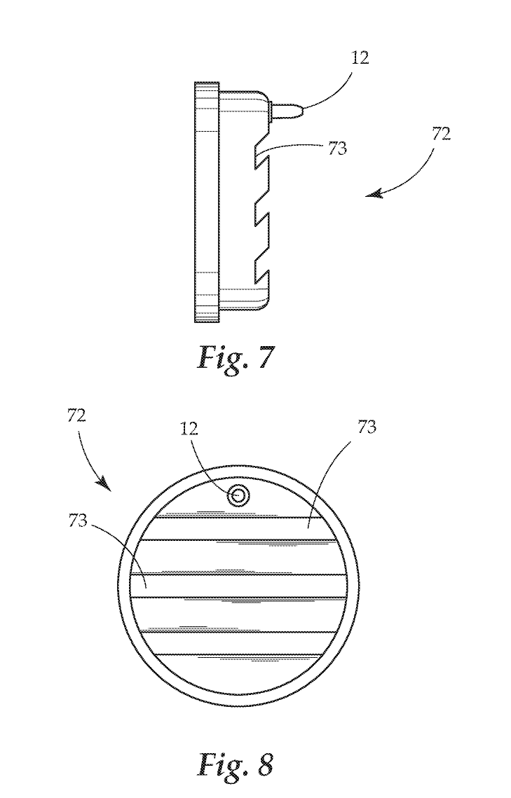

### REFERENCE NUMERALS IN THE DRAWINGS FOR FIGS. 7 AND 8

72 Nozzle having upwardly angled fins
73 Upwardly angled fin

### DETAILED DESCRIPTION

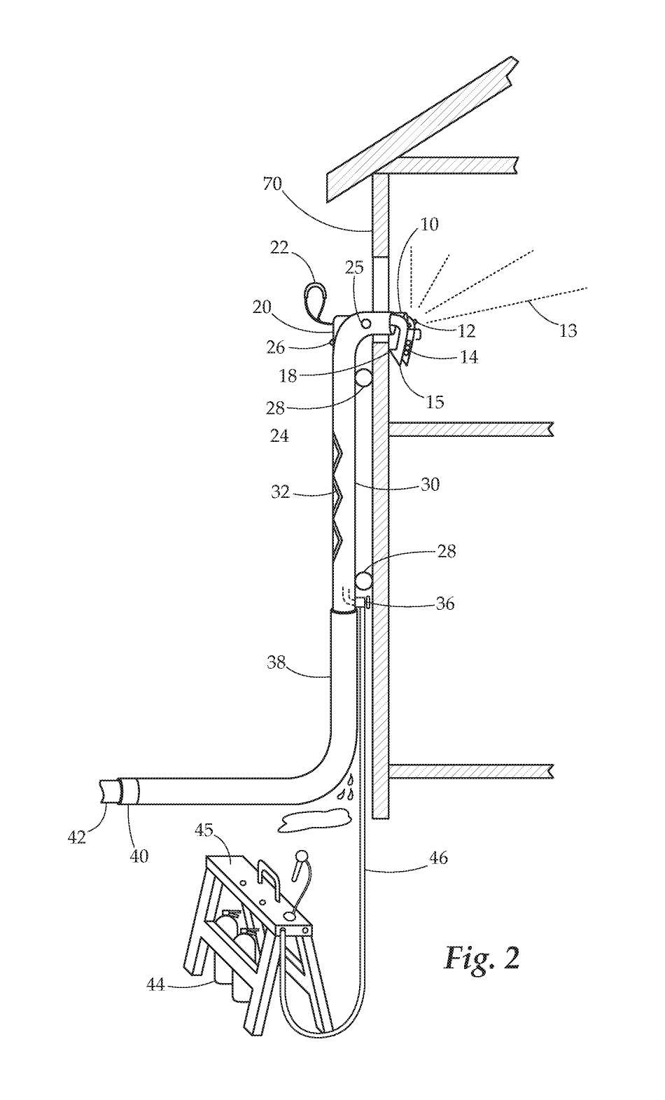

FIGS. 1 and 2 provide views of the multi-functional fire attack device of the present invention. The nozzle 10, as shown in more detail in FIG. 3 is designed to flow in multiple directions and allow for the flow of four different extinguisher types (water, foam, dry chemical, and gas such as CO₂, aerosol, and the like). A typical deployment of the Multi-Function Fire Attack Device, such as that shown in FIG. 2 may include slamming the device through a glass window in an area of the fire. The tempered glass breakers 12, shown here as protruding nubs on the stability hooks 15 may facilitate this.

Turning to nozzle operation and FIG. 3, the dry chemical fire extinguisher 44 may be sprayed by nozzle 10, either before, after, or instead of a quantity of water sprayed by the nozzle 10. The agent would travel up the extinguisher hose section 46 through the extinguisher connection 36 up the rigid pipe 24 and out through the relatively large gap created by the Low-Pressure to High-Pressure Compression Spring 53. Some of the agent (or other substance sprayed through the nozzle) may also flow through the Reverse Flow Ports 54. The spring 53 requires more pressure than can be delivered by the fire extinguisher, thus remaining uncompressed. The opening between the Automatic Low-Pressure Tip 50 and the Automatic High-Pressure Tip 51 allows the dry chemical (ABC, etc.), and gas (CO2 or Aerosol, etc.) to pass through in a flooding type spray pattern. Water can be applied through the standard hose 42 and travel through the weeping hose section 38 into the rigid pipe section 24 and out through the nozzle between 50 and 51. Until the compression spring 53 reaches sufficient pressure to close the space between 50 and 51, the relatively low pressure water will automatically help flush any remaining residue in the line and nozzle. Once the water pressure sufficiently compresses the spring 53, an increased flow of water (or other substance being sprayed by the nozzle 10) passes between 51 and 52 increasing in velocity and breaks up as it passes by the Water Break up Teeth 68. Water will also flow through the Reverse Flow Ports 54 towards the outside of the building 70 and away from the primary spray direction of the nozzle 10. Reverse flow ports 54 help prevent oxygen rich air from entering the structure. The shape of the forward discharge on FIG. 3 is an open circle pattern with the closed end facing the floor. This closed end will reduce the hydraulic vacuum created by traditional fog nozzles, further protecting air infiltration. The floor-facing closed end may also reduce incidental water damage. In one embodiment, as the water pressure rises to about 50 psi up to 300 psi the Automatic Gallon Compression Spring 60 compresses allowing more gallons per minute to flow through the nozzle FIG. 3 in a diffused spray pattern. This nozzle may also use class A or B foam and follow the same path as water did to create foam as it leaves the nozzle.

This unmanned automatic nozzle 10 combines the benefits of bi-directional spray and is self-flushing. It seamlessly flows four major types of extinguishing agents as later noted herein, and has variable gallons per minute capabilities. The components of the nozzle 10 depicted can be custom made out of many materials including but not limited to: aluminum, brass, stainless steel, steel, plastic, PVC, cast iron, ceramic, alloys, titanium, rubber, wood, injected plastics, gold, silver, glass, bronze, copper, tin, cement, asbestos or other durable materials. The components can be cast, injected, threaded, screwed or welded together.

FIG. 1 shows a perspective view of the present device in an assembled state. The Multi-Function Fire Attack Device is an assembly of many components. One intent of operation of the present invention is to rapidly deploy it from the exterior at a structure fire and apply extinguishing agents and or water into the fire area of the structure. In a preferred embodiment, the device would be pre-connected to a fire truck. Upon arrival to the scene, the officer would remove this pre-connected device from the fire truck and pinch it under one arm. In the other hand, the officer may carry a fire extinguisher assembly 45. As part of their 360-degree survey of the fire, the officer would move to the area of the fire. After reaching the fire area, the officer would decide upon the best window or glass door opening to deploy this invention. Choosing to deploy it in a small window is preferable to a large plate glass window or full-length glass door. One strategy is to quickly reach the fire, break the least amount of glass, and utilize the hooks to allow for unmanned operation. Initial experiments have revealed that striking the window in the bottom corner typically breaks out less glass. In one motion, the device can be forcibly swung at the lower corner of the window, utilizing the tempered glass breaking tips 12. In an embodiment where the device is to be used in an elevated window, rigid pipe 24 allows the nozzle 10 to be elevated and controlled. The nozzle 10 may be adjustable in direction, for example by a hinge or swivel, to be used on lower levels. The pipe section behind the nozzle area 25 can be forced downward securing it to the window opening. The hooks will hold it in place against the strong nozzle reaction forces.

The heat sensitive decals 32 turn black or are melted when exposed to temperatures above 300 degrees. Exposures above this temperature would indicate high heat and the need for factory inspection and re-certification. Fire room temperatures typically do not reach over 300 degree at the bottom of windows until the room reaches flashover. This invention has self-preserving features:
a. The Reverse Flow Ports 54 soaks the invention and runs down the outside Rigid Pipe 24.
b. The nozzle 10 spray pattern blocks direct flame impingement and radiant heat.
c. Weeping structure offsets 28 reduce heat and fire damage by spacing the rigid pipe 24 away from the burning building 70 outer surface.
d. Weeping fire hose 38 helps prevent fire line burn through.
e. The water filled device would transfer heat to the water.
   While one firefighter is deploying the Multi-Function Fire Attack Device, another could be installing the Self-Sealing Hose Pass-Through Devices 49. The inventive pass-through device 49 is positioned in a hole or opening in the door, such as through a window, window opening, hole in a door or wall, and the like. The pass through device 49 includes an outer portion which connects to the portion of the building being passed through, and includes a plurality of flexible fingers, or members facing inward from the outer portion. These fingers or members allow passage of a hose, but limit spacing around the hose, thus liming air flow into the building but allowing firefighters to bring the hose for interior firefighting. Once the Multi-Function Fire Attack Device is in place, one of the two fire extinguishers 44 can be deployed through the extension hose 46 and travel all the way to the Bi-Direction 4-Function Nozzle 10. As the relatively low-pressure extinguisher discharge enters the nozzle, most of the extinguisher agent flows through the larger low-pressure opening 50-51 and diffuses into a flooding type spray into the structure. A small amount of the extinguisher flows through the Reverse Flow Ports 54 to form a cone shaped seal of the broken glass area to inhibit oxygen rich air infiltration into the structure.
   Some of the benefits from deploying the ABC dry chemical (the most universal type extinguisher) from this device would be the following:
A rapid two punch fire attack when used in conjunction with water.
The Multi-Function Fire Attack System is the only interior attack a 3 man Engine Company can make and still be in compliance with OSHA regulation (29 CFR 1910.134). This regulation states you must have a minimum of 4 firefighters (2 in 2 out) on scene to conduct interior fire attack. Using this Multi-Function Fire Attack System, no members of the crew enter the IDLH (Immediate Danger to Life and Health) environment during the initial device deployment.
Begin substantial fire suppression even before the pump operator is ready to deliver water or foam.
Significantly less damage to property versus traditional water attack lines.
Does not upset the thermal layers as much as water.
Unlike water, which mainly attempts to cool the combustion fuels below their ignition point and absorb heat through steam conversion, dry chemical agents disrupt the chemical reaction between fuel, heat and oxygen.
The agent releases carbon dioxide when it reaches 150 degrees F., which displaces the oxygen in the area of combustion.
Dry chemical agents also create a crust on combustibles inhibiting pyrolysis.
Dry chemical is preferred for electrical fires or kitchen grease fires.
Dry chemical would be the preferred agent at the incipient phase of a fire, before ceiling temperatures reach 212 degrees (which would begin the steam conversion effect of water discharged from this invention).
Small bursts of agent could help hold a small fire.
A full discharge of the extinguisher could darken down the room and allow the firefighter to join the crew that is waiting to enter.
If at any point during the fire attack, water was lost, dry chemical extinguishers could be rounded up and be deployed through the extinguisher port to continue fire attack until water supply can be regained.

The device also has many other functions. If the window is blocked by a screen or shudder, the screen ripper 16 can be used to remove them before striking the glass with the glass breakers 12. Once the invention has been secured to the structure, smoke will automatically activate the onboard electronics. For low smoke conditions or for exterior use, an activation button is located near the battery box 20. The lights and fire alarm serve many functions as previously outlined in the above section BRIEF SUMMARY OF THE INVENTION. This device has multiple emergency egress functions. The charging of the hose also inflates the two weeping structure offsets 28. These offsets serve to both help secure the hooks 15 to the structure and help keep the rigid pipe 24 away from the exterior, which would be important in the event of using this invention as an emergency safety slide. The gap created 30 by the offsets would allow firefighters to more easily grasp the pipe with their hands, knees, and feet. The firefighter could do a head first bailout of the room, putting one of the firefighter's arms into the Emergency Bailout Handle opening 22 and hooking the handle with their elbow. Bringing their first up toward their shoulder would create a surprisingly strong hold to the invention. While the firefighter clears the window headfirst, their body would flip and twist out and collide against the structure and ridged pipe section 32. The bailout handle is flexible and sprung to remain upright as in FIG. 1. The handle section is ridged so as not to collapse and completely lose shape like a rope would. The attachment point 20 is also flexible enough to allow for the twisting motion created by a head first bailout. They could begin to grasp the pipe with their free hand, knees, and feet and begin to release their hold with their elbow as they slide down the pipe. After the firefighter releases the bail out handle, the handle would spring back into place for additional firefighter bailouts. While this type of self-rescue is inherently dangerous, it is preferable to remaining in a structure undergoing flashover or structural collapse. Another firefighter option would be to snap a Carabiner into the stability hooks 15 or Emergency Bailout Handle 22 to use as a rescue rope anchor. A firefighter attempting to bail out of the structure could also use a ground ladder with minimal interference from this low profile snag resistant invention. News videos of fires have captured firefighters bailing out of windows and getting caught on ladders or even jumping to the ground. Firefighters could also clip into the Bailout handle with a truck belt or harness, and remain hanging against the building until someone with a ground ladder is able to help.

A wireless infrared camera 11 may give real time information to command and crew members using the monitors or smart phones. The monitor can be hand held or mounted to the fire helmet for flip down viewing in front of one eye 47, which may be movable out of eye view, such as in the side position 48. Some camera models include wireless audio and visual connections to fire scene cell phones, laptops or tablets.

When the above-mentioned components are combined with the Self-Sealing Hose Pass-Through Device 49, interior firefighters enjoy more protection from adverse fire behavior. Traditional fire attack creates an uncontrolled flow of oxygen rich air into the structure by forcing the door wide open during the hose line advance. After the initial advance, the door can still only be partially closed and must be re-opened for more line advance. Now crews can enter the structure, close the door, and advance the lines with the door remaining closed, which makes the fire environment dramatically safer. The Self-Sealing Hose Pass-Through Device can also be used with the Multi-Function Fire Attack Device to help mechanically seal the glass intrusions. A firefighter can place a Self-Sealing Hose Pass-Through Device on the front of the glass breakers to help mechanically seal the broken glass area prior to slamming it against the window. First responders, who may be well in advance of a fire truck and reliable water, would probably best use this option. The adhesive side of 49 has an open cell foam layer to help promote glass seal before breakage. The Self-Sealing Hose Pass-Through Device can be custom made out of a variety of materials or combinations of materials including but not limited to: plastic, canvas, paper, abs plastic, PVC, CPVC, cotton, wool, blended fabrics, wood, metal, rubber, leather, vinyl, etc. The seal will be available in single sided or double-sided configurations. The preferred penetration would be through the hinge side of a door near the floor. Other locations on the door will work but be less effective or useful. The pass through-devices can even be installed on any exterior portion of a structure including walls, doors, windows, foundations, roofs, soffits, eaves, or floors.

The Pass-Through device can be secured with clips, hooks, adhesive, nails, tacks, screws, or any combination including friction fit, tapered fit, or twisted fit. The preferred embodiment will be dish shaped with a slotted center to allow the nozzle and hose to pass-through and a rubber cuff protecting the hose from sharp edges. A large variety of models will be available. Some will be as simple as plastic plates with slotted centers and adhesive backs to stick on the door or structure penetration area. Others will have bristles, or simple flaps of material over the penetration area. The pass-through device 49 will have a gliding surface to protect the hoses against cuts or abrasions. The objective is to provide a seal to the structure opening, which allows a nozzle, and hose line to be pulled through, and that blocks some of the air from either entering or exhausting. The Multi-Function Fire Attack Device is an assembly of components as outlined in FIG. 1. The components can be assembled together with fire department style pipe thread. Specific types of threads can be custom ordered. The components will also be available in a single rigid section or in a welded configuration. The rigid pipe section can be custom made in various materials including but not limited to steel, aluminum, ceramic, glass, PVC, cpvc, poly pipe, copper, brass, alloys, titanium, cement, and asbestos. It will be available in the following sizes: 1″, 1½″, 2″, 2½″, 3″, 4″, 5″, 6″ or any custom sizes between ¼″ and 10′ if needed.

FIGS. 5 and 6 provide views of another embodiment of the pass through device of the present invention. This embodiment is configured as a door sweep and is attachable after a portion of a building door—such as ten inches to two feet—has been cut or broken off the door. A connector 69 may then connect to the bottom of the door after it has been cut. Fabric or other non-combustible members act as a door sweep material 71 descend downward to contact the ground and limit air intrusion. The door sweep material 71 is connected to the connector 69 by a fastener strap 74. This door sweep material 71 is flexible and movable so that a hose, equipment, a user's hand, a user, and the like can pass through easily. In use, once the door has been cut and the pass through device attached, fire hoses may be easily passed under the door to allow access of firefighters and hoses, and at the same time the device prevents access of excessive air flow which can increase fire danger.

FIGS. 7 and 8 provide detail views of other embodiments of a nozzle. In this view, the nozzle 72 can be connected to a hose at a first end, and flow is directed upwardly by fins 73. A glass-breaking protrusion 12 is positioned on a top of the nozzle 72 to easily break glass as the nozzle 72 is inserted through a window or other opening. In some embodiments, the glass breaking protrusion 12 may further operate as a screen ripper, having a sharpened leading edge, and optionally a rearward angled hook. In a particular embodiment, glass breaking protrusion 12 may have a flat or angled head with a sharp tip. The head may further comprise a screen ripper such as a hook or arrowhead shape. In this embodiment, the nozzle 72 can be used in embodiments such as that of FIGS. 1 and 2 as an alternative to nozzle 10. In some cases, nozzle 72 may be a non-mechanical alternative to nozzle 10. However, it is to be understood that in varying embodiments, conventional nozzles for fire hose usage may also be used as the nozzle for the nozzle assembly without straying from the scope of the present invention.

In summary, the present invention includes a number of innovative features providing enhanced and safer firefighting solutions. Examples of features of the present invention include, but are not limited to:
The creation of a lightweight, rapidly deployable, Multi-Function Fire Attack System, which is integrated, expandable, and full of safety features.
The fastest most versatile interior fire attack device in the business.
A multi-tool with screen and or shutter ripper which may be attached to the operation end of the multi-function fire attack device.
A tempered safety glass or multi-pane glass breaker.
An automatic remote real time infrared camera with sound.
An automatic victim alert motion sensor.
An automatic interior fire locator strobe.
An automatic audio fire locator.
An automatic light and audio orientator.
Extended reach deployment capabilities.
Manned or unmanned deployment capabilities.
Removable hooks to use invention through the wall, roof, floor, soffit, etc.
A self-preserving close proximity tool.
A sacrificial design with relatively inexpensive components.
A self-rescue rope anchor.
A low profile snag resistant design for bailout.
A hand or arm grab for bail out and slide.
A smooth coupling design for smooth rescue slide.
An Automatic Bi-Directional four Function Nozzle, which deploys each extinguisher type alone or in numerous combinations.
   1. Water
   2. Foam
   3. Dry chemical
   4. Gas (CO2, aerosol etc.)
An unmanned device, controlled by radio communications to the pump operator.
Smoke activated audible alarm, locator, orientator, motion sensor, wireless infrared camera, wireless monitors, and evacuation alarm.
A Self-Preserving Weeping Hose Section.
A safe haven space under the ceiling spray.
Rollover protection from ceiling aimed spray.
Flashover protection from ceiling aimed spray.
A rapid through the glass fire attack with outside air infiltration protection.
Invention interfaces with smart phones, tables, and monitors.
Invention connects to many standard fire extinguishers and converts them into flooding agents.
Direct foam capabilities.
Electrical Hazards warning decals.
Multiple invention deployments can be made with Self-Sealing Hose Pass-Through Devices in areas not directly threatened with fire so water doesn't have to be flowing to seal against outside air.
A stand up grab handle for anchor or direct bailout.
First responder transportable and deployable independent of fire truck or hose.
Open circle fog design for reduced hydraulic ventilation effect.
Invention supports truck mounted dry chemical or gas discharge.
Invention can be deployed by firefighters, first responders, police, or trained civilians to begin fire attack well before the fire department arrives.
Expandable or removable platform. Example: After a confirmed evacuation, the invention can be shut down and the expensive electronics can be quickly removed so the invention can be redeployed to aid in extinguishment.
Can be built to use 1″, 1½″, 2″, 2½″, 3″, 4″, 5″, 6″ or any custom sizes between ¼″ and 10′ if needed.
Rigid pipe section can be replaced or swapped for flexible fire hose section.
Many materials can be used to make the rigid pipe section including but not limited to: steel, aluminum, ceramic, glass, pvc, cpvc, poly pipe, copper, brass, alloys, titanium, cement, and asbestos.
Pipe section can be further protected with a close proximity sleeve made with various types of fire resistant materials like Nomex or aluminum heat shield.
Invention is ready to accept large truck mounted extinguisher deployment.
Invention can be deployed without a connection to a fire hose as a rapidly deployed reaching fire extinguisher delivery system, which can later be connected to a fire hose.
Creation of Self-Sealing Hose Pass-Through for doors, wall, floors, ceilings, soffits, roofs, and glass doors or windows.
This fire attack system represents a comprehensive ventilation limited fire attack when used with 49.
The Self-Sealing Hose Pass-Through Device 49 can be stacked in an overlapping fashion to allow for multiple hand lines with large bails and nozzle handles. The device comes with an all weather open cell foam adhesive strip and tear away slots to make them stackable.
Radio controlled solid fire stream option for seat of the fire applications.
Expandable with threaded pipe sections to reach higher floors.
Command has access to real time fire area behavior; audio, video, temperature, as well as victim alert monitoring and downed firefighter monitoring.
Multiple devices can be monitored simultaneously.
On scene firefighters using a smart phone, have access to some of the above information.
A training adaptor will measure the intensity of a strike. This foam adaptor will drive out an indicator measuring the impact. This aid will help firefighters get the feel of using this tool with just enough force to make a good break.
Interchangeable nozzle heads for full fog, straight stream, deluge, right spray, left spray, up spray, down spray, and combination.
Special hook for through the wall, floor, roof or soffit applications.
Infrared thermometer capabilities.
Relatively low cost replaceable components designed to be sacrificial if necessary.
Fire trucks can be built to deliver dry chemical extinguishers directly through the pre-connected hose lines. These agents can be plumbed ahead of the pump impeller. A deluge of dry chemical will break the chemical reaction and water can be used judiciously through the Automatic Bi-Directional 4-Function Nozzle.
The combination of all the above components creates a comprehensive and safer fire attack system.

What is claimed is:

1. A multi-functional fire attack device comprising:
a hose;
a nozzle assembly having a nozzle, the nozzle in fluid communication with the hose; and
a hook attached to the nozzle assembly, the hook extending downwardly from the nozzle and configured to hold the nozzle in place when the nozzle assembly is passed through an opening in a building.

2. The multi-functional fire attack device of claim 1 wherein the nozzle assembly further comprises a second spray nozzle oriented to spray in a rearward direction.

3. The multi-functional fire attack device of claim 1 further comprising a fire extinguisher in communication with the nozzle assembly.

4. The multi-functional fire attack device of claim 1 wherein the nozzle comprises a low pressure portion and a high pressure portion, a spring valve controlling flow through one of the low pressure portion and the high pressure portion based on a pressure within the hose applied to the spring valve.

5. The multi-functional fire attack device of claim 1 further comprising a spacer connected to the hose, the spacer being in fluid communication with the hose and having a weeping hose portion such that, when water passes through the hose, a portion of the water seeps through the spacer weeping hose portion.

6. The multi-functional fire attack device of claim 1 further comprising a camera positioned on the nozzle assembly, the camera oriented in a forward direction.

7. The multi-functional fire attack device of claim 1 wherein a front edge of the hook comprises a window-breaking protrusion.

8. The multi-functional fire attack device of claim 1 wherein the nozzle assembly is configured to spray a mist substantially upward and forward from the nozzle.

9. The multi-functional fire attack system of claim 1 further comprising a smoke detector positioned on the nozzle assembly, the smoke detector configured to perform at least one of activating at least one electronic component positioned on the nozzle assembly and opening a flow through the nozzle.

10. The multi-functional fire attack device of claim 1 further comprising a motion sensor.

11. The multi-functional fire attack device of claim 1 wherein the hose comprises a rigid pipe portion.

12. The multi-functional fire attack device of claim 1 further comprising a battery on the nozzle assembly, the battery in communication with at least one electronic device of the nozzle assembly.

13. The multi-functional fire attack device of claim 1 further comprising a fire extinguisher in communication with the nozzle assembly and wherein the nozzle is capable of spraying a fire extinguisher component and a water from the hose in series.

14. The multi-functional fire attack device of claim 1 further comprising a handle on a rear portion of the nozzle assembly.

15. The multi-functional fire attack device of claim 1 further comprising a computerized display in wireless communication with an electronic device of the nozzle assembly.

16. A building comprising the multi-functional fire attack device of claim 1 attached to at least one of a window frame, a door, and a ridge, the hook engaged with the at least one of the window frame, door, and ridge and the nozzle oriented to spray into the building.

17. A building hose pass-through device comprising:
a connector attached to a bottom of a door, the connector positioned over a majority of a lengthwise edge of the door;
a quantity of flexible and non-flammable material connected to the connector by a fastener, the quantity of material descending downward from the connector; and
a hose passing under the door and in contact with the quantity of material, the quantity of material limiting air flow beneath the door.

18. The building hose pass-through device of claim 17 wherein the quantity of material is a non-flammable fabric.

19. The building hose pass-through device of claim 17 wherein the a door latched in position.

20. A building comprising a multi-functional fire attack system, the multi-functional fire attack system comprising a multi-functional fire attack device and a building hose pass through device, the multi-functional fire attack device comprising:
a hose;
a nozzle assembly having a nozzle, the nozzle in fluid communication with the hose;
a hook attached to the nozzle assembly, the hook extending downwardly from the nozzle and configured to hold the nozzle in place when the nozzle assembly is passed through an opening in a building;
the multi-functional fire attack device attached to at least one of a window frame, a door, and a ridge, the hook engaged with the at least one of the window frame, door, and ridge and the nozzle oriented to spray into the building;
the building hose pass through device comprising:
a connector attached to a bottom of a door, the connector positioned over a majority of a lengthwise edge of the door;
a quantity of flexible and non-flammable material connected to the connector by a fastener, the quantity of material descending downward from the connector; and
a second hose passing under the door and in contact with the quantity of material, the quantity of material limiting air flow beneath the door.
